(19) United States
(12) Patent Application Publication
(10) Pub. No.: US 2026/0366534 A1
(43) Pub. Date: Nov. 19, 2026

(54) VEHICLE AIR COMPRESSOR

(71) Applicant: HANON SYSTEMS, Daejeon (KR)

(72) Inventors: Hyun Chil KIM, Daejeon (KR); Gun Woong PARK, Daejeon (KR); Min Gyu PARK, Daejeon (KR); Jun Hyuk PARK, Daejeon (KR); Chi Yong PARK, Daejeon (KR); Hyun Sup YANG, Daejeon (KR); Jong Sung LEE, Daejeon (KR); Yong Ha CHAE, Daejeon (KR); Kyu Sung CHOI, Daejeon (KR)

(21) Appl. No.: 19/142,744

(22) PCT Filed: Jan. 10, 2024
(86) PCT No.: PCT/KR2024/000466

§ 371 Date: Jun. 24, 2025

(30) Foreign Application Priority Data
Feb. 6, 2023 (KR) 10-2023-0015683
Apr. 21, 2023 (KR) 10-2023-0052683

(51) Int. Cl. F04D 29/58; F04D 29/44; H02K 5/20; H02K 9/19

(52) U.S. Cl. CPC F04D 29/582; F04D 29/441; H02K 5/203; H02K 9/19

(57) ABSTRACT

An embodiment relates to a vehicle air compressor which has been improved so that compressed air evenly cools a housing over the entire area thereof. The vehicle air compressor comprises: a compression part comprising a first cover forming an inlet passage through which air flows in; and a compression impeller for compressing the air flowing in through the inlet passage; and a drive part comprising a rotor coupled to the compression impeller, a rotor disk which is integrated into the rotor, a stator disposed on the outside of the rotor, and a motor housing which surrounds the stator and has an air flow part formed therein, through which compressed air that has been compressed by the compression impeller flows.

### TECHNICAL FIELD

The present invention relates to a vehicle air compressor.

### BACKGROUND ART

A vehicle air compressor may perform a function of compressing air suctioned from the outside using an impeller and then sending the compressed air to a fuel cell stack.

A vehicle air compressor may include a rotor, a stator, a housing that accommodates the rotor and the stator therein, a compression impeller that is disposed in the housing and compresses air, an introduction cover formed to allow external air to be introduced, a discharge cover through which the compressed air is discharged, and a turbine impeller that is disposed inside the discharge cover, is rotated by the air exhausted from a fuel cell, and reduces a load on the rotor. A cooling water flow portion that accommodates cooling water is formed in the housing.

The vehicle air compressor has a problem of generating heat due to high-speed rotation of the rotor. Accordingly, in the conventional vehicle air compressor, the interior of a housing is cooled through a structure in which compressed air that is compressed in a compression impeller flows through a channel formed inside the housing and the compressed air passing through the channel moves the interior of the housing while being cooled by being heat-exchanged with cooling water accommodated in a cooling water flow portion.

However, since the conventional vehicle air compressor has a structure in which a channel through which the compressed air flows reciprocates once from one end to the other end in a longitudinal direction of the housing, a side of the housing on which a discharge cover is disposed has a smaller cooling effect from the compressed air than a side of the housing on which an introduction cover is disposed. Accordingly, there is a problem that the components disposed on the side of the housing on which the discharge cover is disposed are damaged by heat, resulting in a decrease in performance.

### DETAILED DESCRIPTION OF INVENTION

### Technical Problem

An object of the present invention is to provide a vehicle air compressor which is improved such that compressed air evenly cools the entire area of a housing.

### Technical Solution

According to an embodiment of the present invention, there is provided a vehicle air compressor including: a compression unit including a first cover that forms an introduction passage through which air is introduced and a compression impeller that compresses the air introduced through the introduction passage; and a driving unit including a rotor coupled to the compression impeller, a rotor disk formed integrally with the rotor, a stator disposed outside the rotor, and a motor housing that surrounds the stator and in which an air flow portion in which compressed air that is compressed through the compression impeller flows is formed, wherein the air flow portion includes: first channels that are disposed to be spaced apart from each other in a radial direction of the motor housing and each have an inlet portion and an outlet portion; second channels that are disposed to be spaced apart from each other in the radial direction of the motor housing, are disposed to be spaced apart from the first channels in a direction in which the rotor rotates, and each have an inlet portion and an outlet portion; and a guide hole that connects the outlet portion of each of the first channels and the inlet portion of each of the second channels and guides the compressed air circulating through each of the first channels to each of the second channels.

The motor housing may include a cooling water hole through which cooling water flows, and the guide hole may be disposed outside the cooling water hole.

The first channel may include: a first inlet hole disposed at a position at which the air passing through the compression impeller first flows inside the motor housing; and a first outlet hole disposed closer to an outer surface of the motor housing than the first inlet hole in the radial direction of the motor housing and connected to one end of the guide hole.

The second channel may include: a second inlet hole connected to the other end of the guide hole; and
a second outlet hole disposed closer to the stator than the second inlet hole in the radial direction of the motor housing.

The first channel may include a first connection hole that connects the first inlet hole and the first outlet hole, and the second channel may include a second connection hole that connects the second inlet hole and the second outlet hole.

The driving unit may include: a diffuser that is coupled to the motor housing, is disposed on one side of the rotor disk, and guides the compressed air passing through the compression impeller; and a cartridge coupled to the motor housing and disposed on the other side of the rotor disk, and a flow space in which the rotor disk is disposed and through which the compressed air passing through the second outlet hole flows may be formed between the diffuser and the cartridge.

The motor housing may include a third connection hole which is connected to the second outlet hole and the flow space and through which the compressed air passing through the second outlet hole flows.

The compressed air passing through the third connection hole may move to the flow space between the rotor disk and the cartridge and then moves between the rotor and the stator.

The vehicle air compressor may further include a turbine unit disposed on a side of the motor housing on which the compression unit is not disposed in a longitudinal direction of the rotor, wherein the turbine unit may include: a turbine impeller disposed on a side of the motor housing on which the compression impeller is not disposed in the longitudinal direction of the rotor; and a second cover that is disposed to surround the turbine impeller and forms a discharge passage through which the compressed air flowing inside the motor housing is discharged.

The vehicle air compressor may further include a bypass unit that connects the motor housing and the second cover and guides the compressed air flowing inside the motor housing to the second cover.

The compression unit may further include a first return portion disposed on an outer surface the first cover, and the first return portion may include a first return hole that is connected to the introduction passage and guides the compressed air passing through the motor housing toward the introduction passage.

The motor housing may further include a second return hole that is connected to an arrangement space in which the stator is disposed and guides the compressed air passing through between the rotor and the stator to an interior of the motor housing.

The motor housing may further include: a third return hole that guides the compressed air guided to the interior through the second return hole toward the first return hole; and a fourth return hole connected to the third return hole and disposed outside the cooling water hole.

The compressed air passing through the fourth return hole may be cooled by the cooling water flowing through the cooling water hole.

The diffuser may further include a fifth return hole that connects the first return hole and the fourth return hole.

### Advantageous Effects

According to embodiments of the present invention, a structure in which a plurality of channels formed inside a motor housing and guide holes connecting the plurality of channels are provided and thus compressed air is circulated a plurality of times can be formed. Accordingly, since the entire area of the motor housing can be cooled evenly, cooling can be sufficiently performed on components on a side of the motor housing on which a discharge portion is disposed. Therefore, the performance of the vehicle air compressor can be maintained.

### DESCRIPTION OF DRAWINGS

FIG. 1 is a front view of a vehicle air compressor according to one embodiment of the present invention.

FIG. 2 is a perspective view of the vehicle air compressor according to one embodiment of the present invention.

FIG. 3 is a perspective view of the vehicle air compressor in which a diffuser and a cartridge are disassembled from a motor housing.

FIG. 4 is a rear perspective view of the vehicle compressor in which the diffuser and cartridge are disassembled from the motor housing.

FIG. 5 is a cross-sectional view along line A-A of FIG. 1.

FIG. 6 is a cross-sectional view along line B-B of FIG. 1.

FIG. 7 is a perspective view of a vehicle air compressor according to another embodiment of the present invention.

FIG. 8 is an exploded perspective view of the vehicle air compressor according to another embodiment of the present invention.

FIG. 9 is a rear exploded perspective view of the vehicle air compressor according to another embodiment of the present invention.

FIG. 10 is a view illustrating the flow of compressed air passing through a first channel.

FIG. 11 is a view illustrating the flow of the compressed air passing through a second channel.

FIG. 12 is a view illustrating the flow of the compressed air passing through a return flow path.

### MODES OF THE INVENTION

Hereinafter, exemplary embodiments of the present invention will be described in detail with reference to the accompanying drawings.

However, the technical spirit of the present invention is not limited to any of the described embodiments but may be implemented in various different forms, and one or more of the components among the embodiments may be used by being selectively coupled or substituted without departing from the scope of the technical spirit of the present invention.

In addition, terms (including technical and scientific terms) used in embodiments of the present invention may be interpreted with meanings that are generally understood by those skilled in the art to which the present invention pertains unless explicitly specifically defined and described, and the meanings of commonly used terms, such as terms defined in a dictionary, may be interpreted in consideration of their contextual meanings in the related art.

In addition, the terms used in the embodiments of the present invention are for describing the embodiments and are not intended to limit the present invention.

In the specification, a singular form may include a plural form unless the context clearly dictates otherwise, and when described as “at least one (or one or more) of A, B, and C,” it may include one or more of all possible combinations of A, B, and C.

In addition, terms such as “first,” “second,” “A,” “B, “(a),” and “(b)” may be used to describe components of the embodiments of the present invention.

These terms are only for the purpose of distinguishing one component from another component, and the nature, sequence, order, etc., of the components are not limited by these terms.

In addition, when a first component is described as being “connected,” “coupled,” or “joined” to a second component, it may include not only a case in which the first component is directly connected, coupled, or joined to the second component, but also a case in which the first component is “connected,” “coupled,” or “joined” to the second component with another component present between the first component and the second component.

In addition, when a first component is described as being formed or disposed “above (over)” or “below (under)” a second component, “above (over)” or “below (under)” may include not only a case in which the two components are in direct contact with each other, but also a case in which one or more other components are formed or disposed between the two components. In addition, when expressed as “above (over)” or “below (under),” it may include the meaning of not only an upward direction but also a downward direction based on one component.

Hereinafter, a vehicle air compressor will be described in detail with reference to the accompanying drawings, the same or corresponding components are denoted by the same reference signs throughout the drawings, and overlapping description thereof will be omitted.

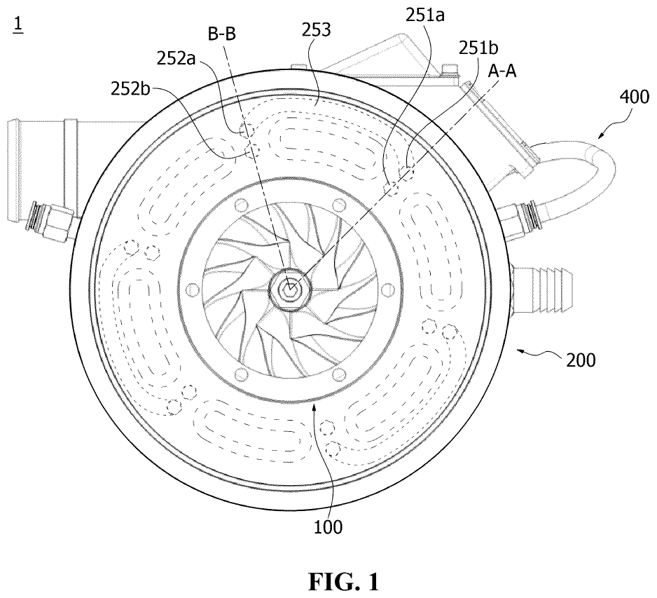

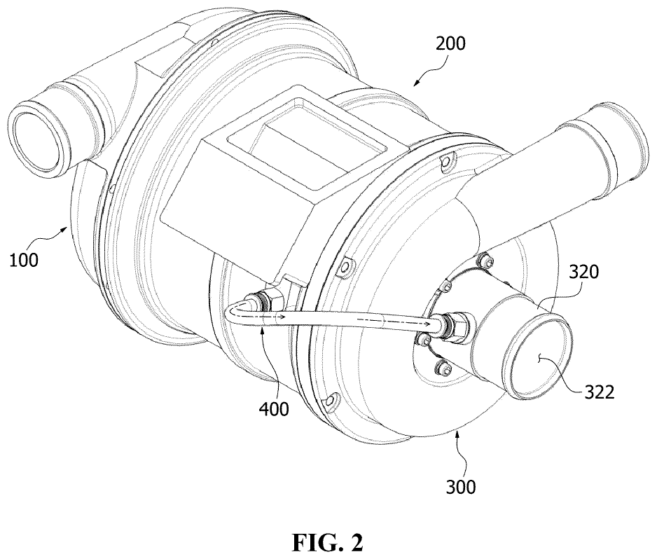

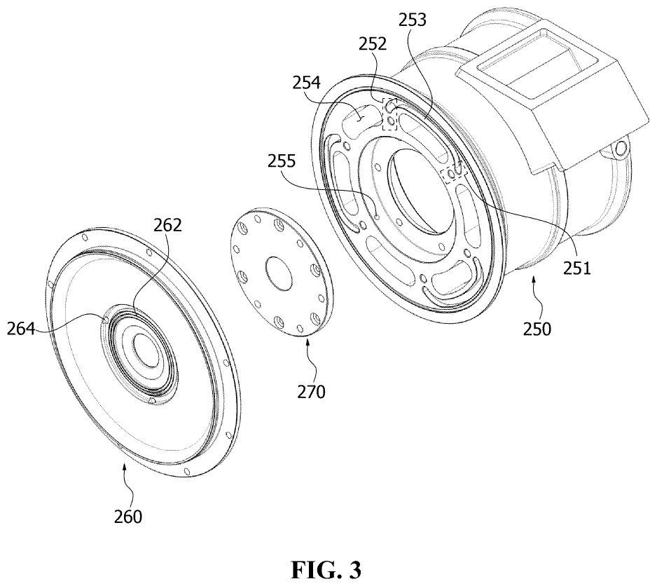

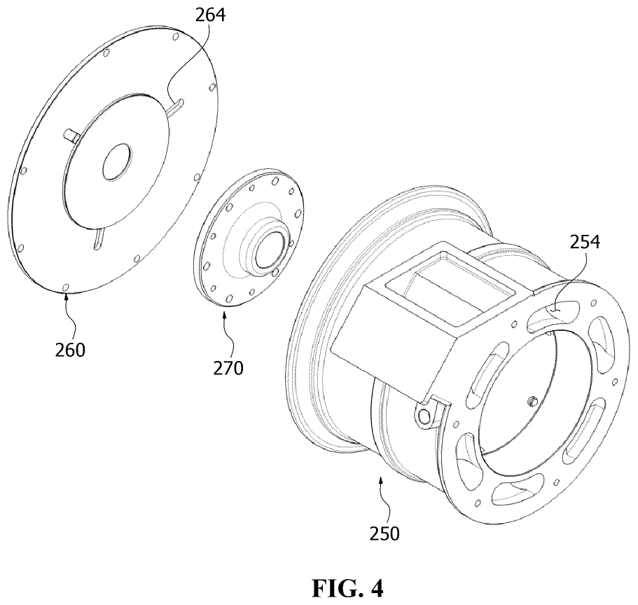

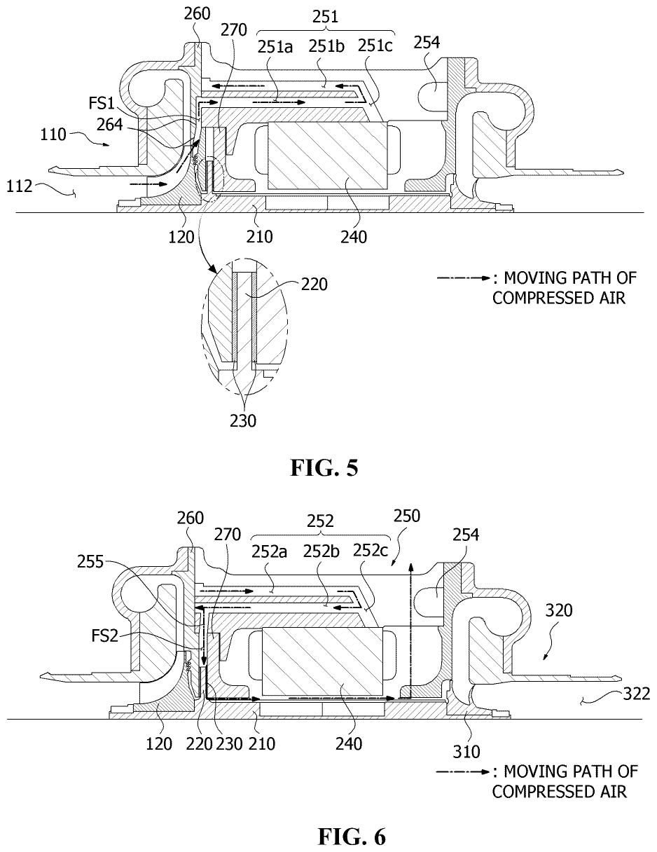

FIG. 1 is a front view of a vehicle air compressor according to one embodiment of the present invention, FIG. 2 is a perspective view of the vehicle air compressor according to one embodiment of the present invention, FIG. 3 is a perspective view of the vehicle air compressor in which a diffuser and a cartridge are disassembled from a motor housing, FIG. 4 is a rear perspective view of the vehicle compressor in which the diffuser and cartridge are disassembled from the motor housing, FIG. 5 is a cross-sectional view along line A-A of FIG. 1, and FIG. 6 is a cross-sectional view along line B-B of FIG. 1.

Referring to FIGS. 1 to 6, a vehicle air compressor 1 according to one embodiment of the present invention may include a compression unit 100, a driving unit 200, a turbine unit 300, and a bypass unit 400. First, a longitudinal direction described in this specification may be a direction from the driving unit 200 toward the compression unit 100 or a direction from the driving unit 200 toward the turbine unit 300.

The compression unit 100 may be disposed on one side of a motor housing 250 of the driving unit 200, which will be described below. The compression unit 100 may compress air introduced from the outside. The compression unit 100 may include a first cover 110 and a compression impeller 120.

The first cover 110 may be disposed on one side of the motor housing 250 in the longitudinal direction and cover one side of the motor housing 250 and the compression impeller 120.

The first cover 110 may include a first introduction portion 112. The first introduction portion 112 may be formed to pass through the first cover 110 in the longitudinal direction. The first introduction portion 112 may be used as a passage through which air is introduced from the outside toward the compression unit 100. The first introduction portion 112 may have a shape in which an internal cross-sectional area gradually increases in a direction from the compression unit 100 toward the driving unit 200.

The compression impeller 120 may be disposed inside the first introduction portion 112. The compression impeller 120 may compress air introduced through the first introduction portion 112. The compression impeller 120 may be rotatably supported on a diffuser 260.

The driving unit 200 may include a rotor 210, a rotor disk 220, a thrust bearing 230, a stator 240, the motor housing 250, the diffuser 260, and a cartridge 270.

The rotor 210 may be disposed inside the motor housing 250. The rotor 210 may have a shape that extends in the longitudinal direction. The rotor 210 may be coupled to a compression impeller 120. When external power is supplied, the rotor 210 may be rotated by electromagnetic interaction with the stator 240. When the rotor 210 is rotated, the compression impeller 120 coupled to the rotor 210 may be rotated. The rotor disk 220 may be formed integrally with the rotor 210. The rotor disk 220 may be provided in a shape that protrudes in a direction intersecting the longitudinal direction. The thrust bearing 230 may be disposed on one side and the other side of the rotor disk 220.

The stator 240 may be disposed inside the motor housing 250. The stator 240 may be disposed outside the rotor 210. The stator 240 may be disposed between the motor housing 250 and the rotor 210. More specifically, the stator 240 may be disposed in a space formed by the motor housing 250 and the rotor 210. The stator 240 may include a plate and a coil.

The motor housing 250 may accommodate the rotor 210, the rotor disk 220, and the stator 240 therein. The motor housing 250 may support the cartridge 270. Accordingly, the motor housing 250 may have a shape that surrounds the rotor 210 and the stator 240. The motor housing 250 may be coupled to the first cover 110.

The diffuser 260 may be coupled to the motor housing 250. The diffuser 260 may be disposed on one side of the rotor disk 220 in the longitudinal direction. The diffuser 260 and an interior of the motor housing 250 may guide air that is compressed through the compression impeller 120 and passes through the compression impeller 120.

The diffuser 260 may include a sealing portion 262 that forms a labyrinth structure together with the compression impeller 120 and cancels out a phenomenon of a load being applied to the thrust bearing 230 and a second introduction portion 264 formed to allow compressed air to flow into the motor housing 250. The second introduction portion 264 may be disposed outside the sealing portion 262 in a radial direction of the diffuser 260. The second introduction portion 264 may include a combination of holes and a groove. The second introduction portion 264 may form a first flow space FS1 through which the compressed air may flow into the motor housing 250 together with the motor housing 250. The second introduction portion 264 may be connected to a first inlet hole 251a which will be described below.

The cartridge 270 may be coupled to the motor housing 250. The cartridge 270 may support the thrust bearing 230. The cartridge 270 may be disposed on the other side of the rotor disk 220 in the longitudinal direction. The cartridge 270 may have a hollow shape to accommodate the rotor 210.

A second flow space FS2, in which the rotor disk 220 and the thrust bearing 230 are disposed, which communicates with a second outlet hole 252b which will be described below, and through which the compressed air passing through the second outlet hole 252b flows, may be formed between the diffuser 260 and the cartridge 270. The second flow space FS2 may be used as a cooling space in which the compressed air may cool the rotor disk 220 and the thrust bearing 230.

Hereinafter, an internal structure of the motor housing 250 will be described in detail.

The motor housing 250 may include an air flow portion formed therein to allow the compressed air that is compressed through the compression impeller 120 to flow. The air flow portion may include first channels 251, second channels 252, guide holes 253, cooling water holes 254, and third connection holes 255. Here, the first channels 251, the second channels 252, and the guide hole 253 may form one connected flow path.

The first channels 251 may be formed to pass through the motor housing 250 in the longitudinal direction. The first channels 251 may be disposed to be spaced apart from each other in a radial direction of the motor housing 250. The first channels 251 may have an inlet portion and an outlet portion. The first channels 251 may include a first inlet hole 251a, a first outlet hole 251b, and a first connection hole 251c.

The first inlet hole 251a may be disposed at a position at which the air passing through the second introduction portion 264 of the diffuser 260 first flows inside the motor housing 250. An end portion of the first inlet hole 251a which is exposed to an outside of the motor housing 250 may be the inlet portion through which the compressed air is introduced. The first outlet hole 251b may be disposed closer to an outer surface of the motor housing 250 than the first inlet hole 251a in the radial direction of the motor housing 250. An end portion of the first outlet hole 251b which is exposed to the outside of the motor housing 250 may be the outlet portion through which the compressed air is discharged. The compressed air passing through the compression impeller 120 may sequentially pass through the first inlet hole 251a and the first outlet hole 251b through the second introduction portion 264 of the diffuser 260. The first outlet hole 251b may be connected to one end of the guide hole 253.

The first connection hole 251c may connect the first inlet hole 251a and the first outlet hole 251b. The first connection hole 251c may guide the compressed air passing through the first inlet hole 251a to the first outlet hole 251b. The first connection hole 251c may be disposed to be inclined with respect to the first inlet hole 251a and the first outlet hole 251b. The first connection hole 251c may be formed to pass through the motor housing 250 from an inner circumferential surface of the motor housing 250 toward the inside of the motor housing 250 for smooth processing. Accordingly, one end of the first connection hole 251c exposed to the outside of the inner circumferential surface of the motor housing 250 may be closed by the stator 240. Therefore, the cost of consuming a separate member for closing one end of the first connection hole 251c can be reduced.

The second channels 252 may be formed to pass through the motor housing 250 in the longitudinal direction. The second channels 252 may be disposed to be spaced apart from each other in the radial direction of the motor housing 250. The second channels 252 may be disposed to be spaced apart from the first channels 251 in a direction in which the rotor 210 rotates. The second channels 252 may have an inlet portion and an outlet portion. The second channels 252 may include a second inlet hole 252a, a second outlet hole 252b, and a second connection hole 252c.

The second inlet hole 252a may be connected to the other end of the guide hole 253 which will be described below. An end portion of the second inlet hole 252a which is exposed to the outside of the motor housing 250 may be the inlet portion through which the compressed air moving through the guide hole 253 is introduced. The second outlet hole 252b may be disposed closer to the stator 240 than the second inlet hole 252a in the radial direction of the motor housing 250. An end portion of the second outlet hole 252b which is exposed to the outside of the motor housing 250 may be the outlet portion through which the compressed air is discharged. The compressed air passing through the guide hole 253 may sequentially pass through the second inlet hole 252a and the second outlet hole 252b.

The second connection hole 252c may connect the second inlet hole 252a and the second outlet hole 252b. The second connection hole 252c may guide the compressed air passing through the second inlet hole 252a to the second outlet hole 252b. The second connection hole 252c may be disposed to be inclined with respect to the second inlet hole 252a and the second outlet hole 252b. The second connection hole 252c may be formed to pass through the motor housing 250 from the inner circumferential surface of the motor housing 250 toward the inside of the motor housing 250 for smooth processing. Accordingly, one end of the second connection hole 252c exposed to the outside of the inner circumferential surface of the motor housing 250 may be closed by the stator 240. Therefore, the cost of consuming a separate member for closing one end of the second connection hole 252c may be reduced.

The guide hole 253 may be disposed on a surface of the motor housing 250 on which the first channels 251 and the second channels 252 are exposed to the outside of the motor housing 250. The guide hole 253 may be disposed outside the cooling water hole 254. Additionally, the guide hole 253 may have a shape that surrounds the cooling water hole 254. Therefore, the compressed air passing through the guide hole 253 may move to the second channels 252 while being heat-exchanged with cooling water accommodated in the cooling water hole 254, and thus the cooling performance for cooling the interior of the motor housing 250 may be maintained.

The guide hole 253 may connect at least one of the first channels 251 and at least one of the second channels 252 and guide the compressed air passing through at least one of the first channels 251 to at least one of the second channels 252. More specifically, one end of the guide hole 253 may be connected to the first outlet hole 251b, and the other end may be connected to the second inlet hole 252a. Accordingly, the compressed air cooling the interior of the motor housing 250 through the first channels 251 may flow once more inside the motor housing 250 and additionally cool the motor housing 250. As a result, heat generated from components disposed inside the motor housing 250 may be prevented from being maintained for a long period of time, and the performance of the components disposed inside the motor housing 250 may be maintained.

The cooling water holes 254 may be disposed on one end portion and the other end portion of the motor housing 250. The cooling water hole 254 may be covered by the diffuser 260 or a second cover 320 which will be described below. The cooling water hole 254 may accommodate the cooling water therein. The cooling water hole 254 may be disposed adjacent to the guide hole 253, the first connection hole 251c, and the second connection hole 252c. Accordingly, the compressed air passing through the first channels 251 and the second channels 252 may be heat-exchanged with the cooling water accommodated in the cooling water hole 254 when the compressed air moves to a position adjacent to the cooling water hole 254 and may be cooled.

The third connection hole 255 may be connected to the second outlet hole 252b. The third connection hole 255 may be connected to the second flow space FS2. The third connection hole 255 may be used as a passage through which the compressed air passing through the second outlet hole 252b flows.

Hereinafter, a path through which the compressed air flows inside the motor housing 250 will be described.

Referring to FIGS. 3 to 6, the air introduced into the introduction portion of the first cover 110 of the compression unit 100 may be compressed while passing through the compression impeller 120. The compressed air compressed by the compression impeller 120 may pass through the second introduction portion 264 of the diffuser 260 connected to the compression impeller 120 and the first flow space FS1.

The compressed air passing through the first flow space FS1 may move to the first inlet hole 251a connected to the first flow space FS1. In this process, the compressed air passing through the first inlet hole 251a may be heat-exchanged with the cooling water accommodated in the cooling water hole 254 shown in FIG. 3. The compressed air passing through the first inlet hole 251a may pass through the first connection hole 251c and move to the first outlet hole 251b. The compressed air passing through the first connection hole 251c may be heat-exchanged with the cooling water accommodated in the cooling water hole 254 disposed adjacent to the first connection hole 251c and may be cooled.

The compressed air moving from the first connection hole 251c to the first outlet hole 251b may pass through the guide hole 253 and move to the second inlet hole 252a. The compressed air moving from the guide hole 253 to the second inlet hole 252a may be heat-exchanged with the cooling water accommodated in the cooling water hole 254 disposed adjacent to the second inlet hole 252a and may be cooled.

The compressed air passing through the second inlet hole 252a may pass through the second connection hole 252c and move to the second outlet hole 252b. The compressed air passing through the second connection hole 252c may be heat-exchanged with the cooling water accommodated in the cooling water hole 254 disposed adjacent to the second connection hole 252c and may be cooled.

The compressed air moving from the second outlet hole 252b may move to the third connection hole 255. Additionally, the compressed air passing through the third connection hole 255 may move to the second flow space FS2 between the rotor disk 220 and the cartridge 270 and then move between the rotor 210 and the stator 240.

The compressed air having this type of flow may cool the interior of the motor housing 250, the rotor disk 220, the cartridge 270, the rotor 210, and the stator 240. Additionally, the compressed air may be periodically heat-exchanged with the cooling water accommodated in the cooling water hole 254 while moving from the first channels 251 to the second channels 252. Therefore, the compressed air moving inside the motor housing 250 may continuously maintain the cooling performance, and thus performance degradation due to the heat of the components disposed inside the motor housing 250 may be prevented.

The turbine unit 300 may be disposed on a side of the motor housing 250 on which the compression unit 100 is not disposed in the longitudinal direction of the rotor 210. The turbine unit 300 may include a turbine impeller 310 disposed on a side of the motor housing 250 on which the compression impeller 120 is not disposed in the longitudinal direction of the rotor 210 and a second cover 320 that is disposed to surround the turbine impeller 310 and forms a discharge portion 322 through which the compressed air flowing inside the motor housing 250 is discharged.

As shown in FIG. 2, the bypass unit 400 may connect the motor housing 250 and the second cover 320. The bypass unit 400 may include a tube used as a passage through which the compressed air may move and a connecting member such as a nut for connecting the tube to the motor housing 250 and the second cover 320.

The bypass unit 400 may guide the compressed air flowing inside the motor housing 250 to the second cover 320. That is, the bypass unit 400 may perform a function of moving the compressed air that moves between the rotor 210 and the stator 240 to the second cover 320 without passing through the turbine impeller 310. This is to prevent the compressed air containing moisture from moving toward the stator 240 due to a backflow phenomenon that may occur when the compressed air passes through the turbine impeller 310 and to prevent causing damage to a wire wound around the stator 240.

The vehicle air compressor 1 according to one embodiment of the present invention forms a plurality of channels for cooling the interior of the motor housing 250 and has the guide holes 253 for allowing the compressed air to flow through the plurality of channels. Accordingly, the vehicle air compressor 1 may be smoothly cooled through a structure in which the compressed air circulates through the interior of the motor housing 250 a plurality of times, and thus the performance of the components disposed inside the motor housing 250 may be maintained.

Hereinafter, a vehicle air compressor 2 according to another embodiment of the present invention will be described. When describing the vehicle air compressor 2 according to another embodiment, the same components as those of the vehicle air compressor 1 according to one embodiment of the present invention are designated by the same reference signs, and description thereof will be omitted.

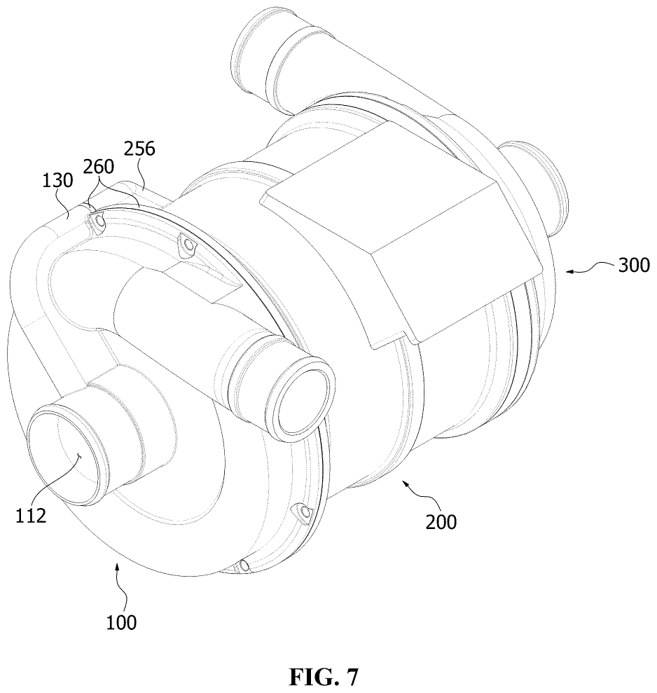

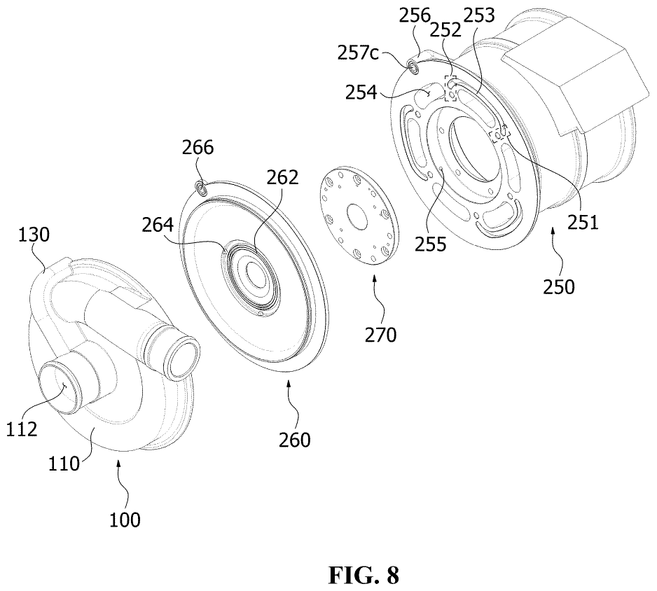

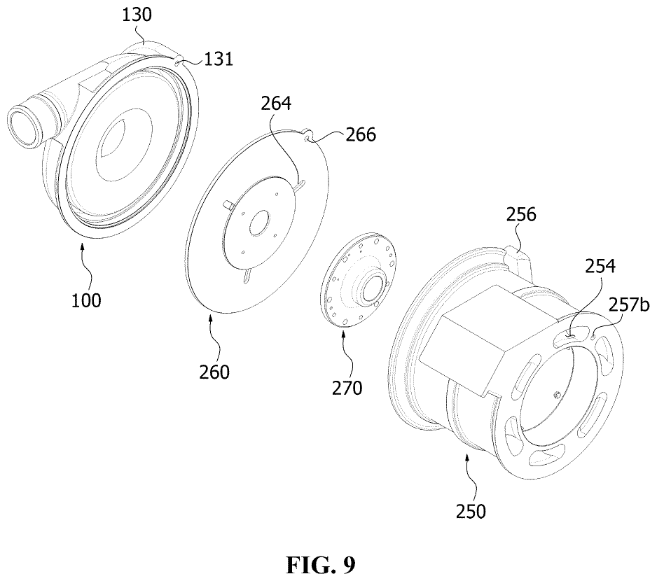

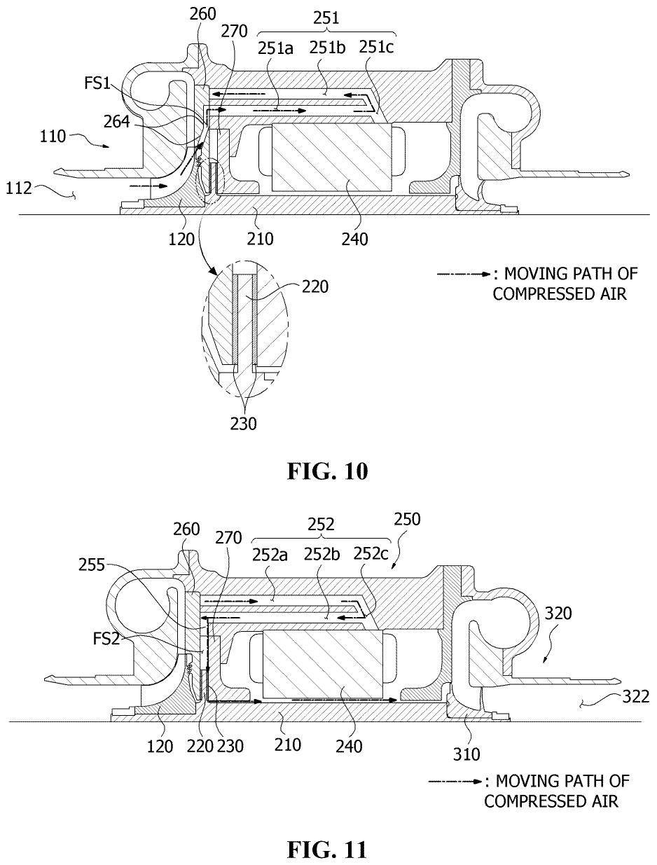

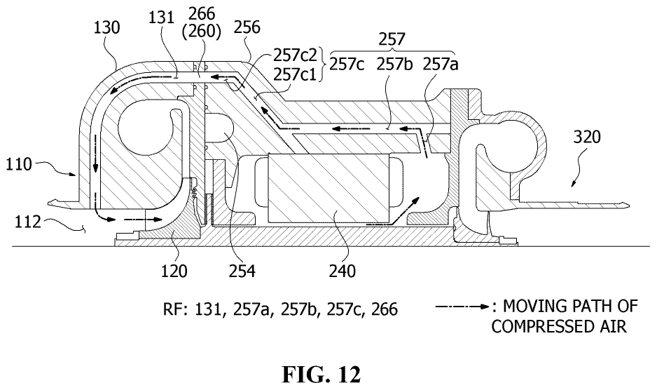

FIG. 7 is a perspective view of a vehicle air compressor according to another embodiment of the present invention, FIG. 8 is an exploded perspective view of the vehicle air compressor according to another embodiment of the present invention, FIG. 9 is a rear exploded perspective view of the vehicle air compressor according to another embodiment of the present invention, FIG. 10 is a view illustrating the flow of compressed air passing through a first channel, FIG. 11 is a view illustrating the flow of the compressed air passing through a second channel, and FIG. 12 is a view illustrating the flow of the compressed air passing through a return flow path.

Referring to FIGS. 7 to 12, the compression unit 100 of the vehicle air compressor 2 according to another embodiment of the present invention may include a first return portion 130, the motor housing 250 may include a protrusion 256 and a second return portion 257, and the diffuser 260 may include a fifth return hole 266. The first return portion 130, the second return portion 257, and the fifth return hole 266 may form a return flow path RF inside the vehicle air compressor 2.

The first return portion 130 may be disposed on an outer surface of the first cover 110. The first return portion 130 may have a shape that protrudes from the outer surface of the first cover 110 toward the outside of the first cover 110. The first return portion 130 may include a first return hole 131.

The first return hole 131 may be formed inside the first return portion 130. The first return hole 131 may have a shape that follows a protruding shape of the first return portion 130 and include a combination of a straight portion 257c2 and a curved portion. The first return hole 131 may be connected to an introduction passage formed in the first cover 110 and guide the compressed air passing through the motor housing 250 toward the introduction passage.

The protrusion 256 may be disposed on the outer surface of the motor housing 250. The protrusion 256 may have a shape that protrudes from the outer surface of the motor housing 250 toward the outside of the motor housing 250. The protrusion 256 may provide a location at which a fourth return hole 257c to be described below is formed.

The second return portion 257 may be disposed inside the motor housing 250. The second return portion 257 may guide the compressed air that completes a cooling function toward the first return portion 130. The second return portion 257 may include a second return hole 257a, a third return hole 257b, and a fourth return hole 257c.

The second return hole 257a may be disposed to be inclined with respect to the third return hole 257b. The second return hole 257a may be formed to pass through the motor housing 250 from the inner circumferential surface of the motor housing 250 toward the inside of the motor housing 250 for smooth processing. The second return hole 257a may be connected to an arrangement space in which the stator 240 is disposed and guide the compressed air passing through between the rotor 210 and the stator 240 into the interior of the motor housing 250.

The third return hole 257b may be connected to the second return hole 257a. The third return hole 257b may be formed to pass through the motor housing 250 from a surface of the motor housing 250 which faces the second cover 320 toward the inside of the motor housing 250 for smooth processing. An open portion of the third return hole 257b may be closed by the second cover 320. The third return hole 257b may guide the air passing through the second return hole 257a.

The fourth return hole 257c may be connected to the third return hole 257b. The fourth return hole 257c may be disposed outside the cooling water hole 254. The fourth return hole 257c may guide the air passing through the third return hole 257b. The fourth return hole 257c may include an inclined portion 257c1 and a straight portion 257c2.

The inclined portion 257c1 may be disposed to be inclined with respect to the third return hole 257b. The third return hole 257b may be formed to pass through the motor housing 250 from the inner circumferential surface of the motor housing 250 toward the inside of the motor housing 250 for smooth processing. One end of the inclined portion 257cl exposed to the outside of the inner circumferential surface of the motor housing 250 may be closed by the stator 240.

The straight portion 257c2 may be connected to the inclined portion 257c1. The straight portion 257c2 may be disposed to be inclined with respect to the inclined portion 257c1. The straight portion 257c2 may be formed to pass through the motor housing 250 from a surface of the motor housing 250 which faces the diffuser 260 toward the inside of the motor housing 250 for smooth processing.

The fifth return hole 266 may be formed in the diffuser 260. The fifth return hole 266 may be disposed near an edge of the diffuser 260. The fifth return hole 266 may connect the first return hole 131 and the fourth return hole 257c. To have such a structure, a portion of the diffuser 260 in which the fifth return hole 266 is formed may have a shape that protrudes along the shape of a part of the first return portion 130 of the compression unit 100 and the protrusion 256 of the motor housing 250.

Hereinafter, a process in which the compressed air flows inside the motor housing 250 of the vehicle air compressor 2 according to another embodiment of the present invention and the compressed air that flows inside the motor housing 250 is returned to the compression unit 100 will be described.

Referring to FIGS. 7 to 11, the air introduced into the introduction portion of the first cover 110 of the compression unit 100 is compressed while passing through the compression impeller 120. The compressed air compressed by the compression impeller 120 passes through the second introduction portion 264 of the diffuser 260 connected to the compression impeller 120 and the first flow space FS1.

The compressed air passing through the first flow space FS1 moves to the first inlet hole 251a connected to the first flow space FS1. In this process, the compressed air passing through the first inlet hole 251a is heat-exchanged with the cooling water accommodated in the cooling water hole 254 shown in FIG. 9. The compressed air passing through the first inlet hole 251a passes through the first connection hole 251c and moves to the first outlet hole 251b. The compressed air passing through the first connection hole 251c is heat-exchanged with the cooling water accommodated in the cooling water hole 254 disposed adjacent to the first connection hole 251c and is cooled.

The compressed air moving from the first connection hole 251c to the first outlet hole 251b passes through the guide hole 253 and moves to the second inlet hole 252a. The compressed air moving from the guide hole 253 to the second inlet hole 252a is heat-exchanged with the cooling water accommodated in the cooling water hole 254 disposed adjacent to the second inlet hole 252a and is cooled.

The compressed air passing through the second inlet hole 252a passes through the second connection hole 252c and moves to the second outlet hole 252b. The compressed air passing through the second connection hole 252c is heat-exchanged with the cooling water accommodated in the cooling water hole 254 disposed adjacent to the second connection hole 252c and is cooled.

The compressed air moving from the second outlet hole 252b moves to the third connection hole 255. The compressed air passing through the third connection hole 255 moves to the second flow space FS2 between the rotor disk 220 and the cartridge 270 and then moves between the rotor 210 and the stator 240.

Referring to FIGS. 11 and 12, the compressed air that moves between the rotor 210 and the stator 240 and is heated by heat exchange with the rotor 210 and the stator 240 moves to the second return hole 257a connected to an internal space of the motor housing 250. The compressed air moving to the second return hole 257a moves from the second return hole 257a to the third return hole 257b. In this case, an open side of the third return hole 257b is closed by the second cover 320. Therefore, the compressed air moving to the third return hole 257b moves toward the fourth return hole 257c.

The compressed air moving from the third return hole 257b to the fourth return hole 257c passes through the inclined portion 257cl and the straight portion 257c2 sequentially and then moves from the straight section 257c2 toward the fifth return hole 266. In this case, an open side of the inclined portion 257cl of the fourth return hole 257c is closed by the stator 240. Therefore, the compressed air moving to the fourth return hole 257c may not move from the inclined portion 257c1 to the internal space of the motor housing 250.

The compressed air moving from the fourth return hole 257c to the fifth return hole 266 of the diffuser moves from the fifth return hole 266 to the first return hole 131 disposed inside the first cover of the compression unit. The compressed air moving to the first return hole 131 moves to the outside of the first return hole 131 along the first return hole 131. In this case, since the first return hole 131 is connected to the first introduction portion 112 of the first cover 110, the compressed air moving to the outside of the first return hole 131 moves to the first introduction portion 112 and then moves to the compression impeller 120.

In this way, the vehicle air compressor 2 according to another embodiment of the present invention may form a return flow path RF in the motor housing 250 to recycle the compressed air that cools the components disposed inside the motor housing 250 while passing through the interior of the motor housing 250. Accordingly, the power consumption of the compression impeller 120 for compressing air is reduced, and thus the power efficiency of the vehicle air compressor 2 may be increased.

[Reference Signs List]

| | |
|---|---|
| 1, 2: Vehicle air compressor | 100: Compression unit |
| 110: First cover | 112: First introduction portion |
| 120: Compression impeller | 130: First return portion |
| 131: First return hole | 200: Driving unit |
| 210: Rotor | 220: Rotor disk |
| 230: Thrust bearing | 240: Stator |
| 250: Motor housing | 251: First channel |
| 251a: First inlet hole | 251b: First outlet hole |
| 251c: First connection hole | 252: Second channel |
| 252a: Second inlet hole | 252b: Second outlet hole |
| 252c: Second connection hole | 253: Guide hole |
| 254: Cooling water hole | 255: Third connection hole |
| 256: Protrusion | 257: Second return portion |
| 257a: Second return hole | 257b: Third return hole |
| 257c: Fourth return hole | 257c1: Inclined portion |
| 257c2: Straight portion | 260: Diffuser |
| 262: Sealing portion | 264: Second introduction portion |
| 266: Fifth return hole | 270: Cartridge |
| 300: Turbine unit | 310: Turbine impeller |
| 320: Second cover | 322: Discharge portion |
| 400: Bypass unit | FS1: First flow space |
| FS2: Second flow space | RF: Return flow pat |

1. A vehicle air compressor comprising:
a compression unit including a first cover that forms an introduction passage through which air is introduced and a compression impeller that compresses the air introduced through the introduction passage; and
a driving unit including a rotor coupled to the compression impeller, a rotor disk formed integrally with the rotor, a stator disposed outside the rotor, and a motor housing that surrounds the stator and in which an air flow portion in which compressed air that is compressed through the compression impeller flows is formed,
wherein the air flow portion includes:
first channels that are disposed to be spaced apart from each other in a radial direction of the motor housing and each have an inlet portion and an outlet portion;
second channels that are disposed to be spaced apart from each other in the radial direction of the motor housing, are disposed to be spaced apart from the first channels in a direction in which the rotor rotates, and each have an inlet portion and an outlet portion; and
a guide hole that connects the outlet portion of each of the first channels and the inlet portion of each of the second channels and guides the compressed air circulating through each of the first channels to each of the second channels.

2. The vehicle air compressor of claim 1, wherein the motor housing includes a cooling water hole through which cooling water flows, and
the guide hole is disposed outside the cooling water hole.

3. The vehicle air compressor of claim 2, wherein the first channel includes:
a first inlet hole disposed at a position at which the air passing through the compression impeller first flows inside the motor housing; and
a first outlet hole disposed closer to an outer surface of the motor housing than the first inlet hole in the radial direction of the motor housing and connected to one end of the guide hole.

4. The vehicle air compressor of claim 3, wherein the second channel includes:
a second inlet hole connected to the other end of the guide hole; and
a second outlet hole disposed closer to the stator than the second inlet hole in the radial direction of the motor housing.

5. The vehicle air compressor of claim 4, wherein the first channel includes a first connection hole that connects the first inlet hole and the first outlet hole, and
the second channel includes a second connection hole that connects the second inlet hole and the second outlet hole.

6. The vehicle air compressor of claim 5, wherein the driving unit includes:
a diffuser that is coupled to the motor housing, is disposed on one side of the rotor disk, and guides the compressed air passing through the compression impeller; and
a cartridge coupled to the motor housing and disposed on the other side of the rotor disk, and
a flow space in which the rotor disk is disposed and through which the compressed air passing through the second outlet hole flows is formed between the diffuser and the cartridge.

7. The vehicle air compressor of claim 6, wherein the motor housing includes a third connection hole which is connected to the second outlet hole and the flow space and through which the compressed air passing through the second outlet hole flows.

8. The vehicle air compressor of claim 7, wherein the compressed air passing through the third connection hole moves to the flow space between the rotor disk and the cartridge and then moves between the rotor and the stator.

9. The vehicle air compressor of claim 1, further comprising a turbine unit disposed on a side of the motor housing on which the compression unit is not disposed in a longitudinal direction of the rotor,
wherein the turbine unit includes:
a turbine impeller disposed on a side of the motor housing on which the compression impeller is not disposed in the longitudinal direction of the rotor; and
a second cover that is disposed to surround the turbine impeller and forms a discharge passage through which the compressed air flowing inside the motor housing is discharged.

10. The vehicle air compressor of claim 9, further comprising a bypass unit that connects the motor housing and the second cover and guides the compressed air flowing inside the motor housing to the second cover.

11. The vehicle air compressor of claim 8, wherein the compression unit further includes a first return portion disposed on an outer surface the first cover, and
the first return portion includes a first return hole that is connected to the introduction passage and guides the compressed air passing through the motor housing toward the introduction passage.

12. The vehicle air compressor of claim 11, wherein the motor housing further includes a second return hole that is connected to an arrangement space in which the stator is disposed and guides the compressed air passing through between the rotor and the stator to an interior of the motor housing.

13. The vehicle air compressor of claim 12, wherein the motor housing further includes:
a third return hole that guides the compressed air guided to the interior through the second return hole toward the first return hole; and
a fourth return hole connected to the third return hole and disposed outside the cooling water hole.

14. The vehicle air compressor of claim 13, wherein the compressed air passing through the fourth return hole is cooled by the cooling water flowing through the cooling water hole.

15. The vehicle air compressor of claim 14, wherein the diffuser further includes a fifth return hole that connects the first return hole and the fourth return hole.
